(19) United States
(12) Patent Application Publication
(10) Pub. No.: US 2011/0296955 A1
(43) Pub. Date: Dec. 8, 2011

(54) MULTI PURPOSE BEVERAGE CONTAINER OPENER

(75) Inventors: Michael Henry Silvers, Ultimo (AU); Sam Tam, Ultimo (AU)

(73) Assignee: Howard Silvers & Sons Pty Ltd, Ultimo, New South Wales (AU)

(21) Appl. No.: 12/795,346

(22) Filed: Jun. 7, 2010

(51) Int. Cl. B67B 7/44; B67B 7/40

(52) U.S. Cl. 81/3.09; 81/3.55

(57) ABSTRACT

A multiple-function beverage container opener for lifting container lid lift tabs comprises a thin, relatively long and narrow body suitable for holding in a user's thumb and fingers. The body has a front edge and top and bottom surfaces, the front edge having a beveled top and undersurfaces at the edge that extends rearwardly at an acute angle with respect to the bottom and top surfaces whereby the opener edge may be slipped under a container lid tab. There is a ring aperture and an aperture for a bottle cap opener in the surfaces at opposite ends and the top and bottom parallel surfaces of the tool is bowed, and the perimeter is curved inwardly and outwardly. The opener is provided which features and is ergonomically-shaped. The bottle cap opener is located towards the end of the opener adjacent to the opposite the beveled edge which is the pry-bar type opener for the pull tab lids.

### RELATED APPLICATION

This application is related to Ser. No. 29/361,088 filed May 5, 2010. The contents of that application are incorporated by reference herein.

### BACKGROUND

The present disclosure relates generally to the field of beverage container openers and more particularly is directed to a multi-purpose opener for such purposes.

This disclosure relates to devices that aid in the lifting of container lid tabs, and particularly to such devices that are easy and convenient to use by persons. More particularly, this disclosure relates to metal can lid lifting devices designed to facilitate prying open metal can lid lift tabs.

Metal beverage container cans have pop top or pull ring can openers. Such pop top or pull ring can openers normally comprise a scored closure formed directly atop the lid of the metal container and a pull ring hinged, riveted, or otherwise suitably secured to the scored closure.

The effort required to raise the tab handle can often intimidate some users of the can opening system and can injure the fingers or fingernails of the user. In a commercial establishment where a plurality of containers must be opened quickly under sometimes unfavorable conditions, considerable discomfort, breakage of fingernails, and bleeding can be encountered by the individuals who are manipulating hundreds of the closures during the course of a work day.

A number of tools exist for opening pull ring cans, twist-off bottle caps, and crimped-on bottle caps. Many of the tools feature a combination of these types of openers embodied in one tool. However, various compromises are present. In many of the multiple-purpose tools various implements disposed on the opener are placed for reasons of manufacturing expediency, and not to enhance the operation or comfort of the opener in the hand of the user.

It is an object of the present disclosure to provide a compact, easy-to-use opener for lifting container lid tabs, and providing other functions associated with opening beverage containers.

### SUMMARY

The disclosure comprises a multi-purpose beverage container opener for lifting container lid lift tabs and opening bottle caps. The opener comprises a thin, relatively elongated and narrow body with two opposite ends. The body is suitable for holding in and by a user's thumb and fingers; the body having a front edge at one end. Between the two ends and connecting sides there are opposite top and bottom parallel surfaces.

The narrow body is arcuate or bowed between its two ends. The front edge includes a beveled surface that extends rearwardly at an acute angle to form the beveled surface with respect to at least one of the top or the bottom surfaces whereby the opener may be slipped under a container lid tab.

There is a bottle opener aperture between the surfaces such that a crown cork cap can be pried from the top of a bottle. There is also a ring aperture for engaging a covering of a beverage container neck or top to permit the aperture to cut the covering to facilitate removal of at least part of the covering.

The multi-purpose beverage container opener is provided for containers of the type having a stay-on tab, and a crimped-on bottle cap.

The tab engagement loop is formed as an outward radial shape. An ring aperture is formed at an opposite end and is adapted to fit on a beverage container lid or covering.

An ergonomically-shaped opener is bowed between the ends such that in the elongated body is bowed form end to end.

The multi-purpose opener further comprises a waist on the side walls between the ends and this provides an ergonomically-shaped opener which extends transversely with respect to the ends of the elongated-shaped handle and for fitting within the user's grasp.

The stay-on tab opener and a pry-type beverage bottle opener are disposed at one end of the elongated body of the beverage container opener. The ring aperture, which is ergonomically-shaped is disposed at an opposing end of the body.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 is a plan top view of the multi-purpose beverage container opener;

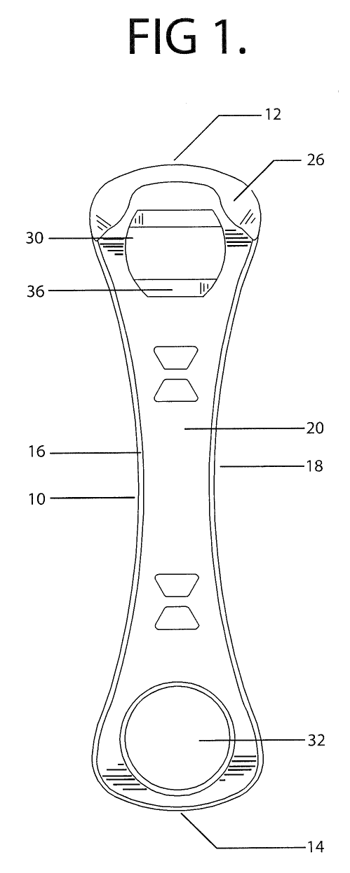

FIG. 2 is a plan bottom view of the multi-purpose beverage container opener;

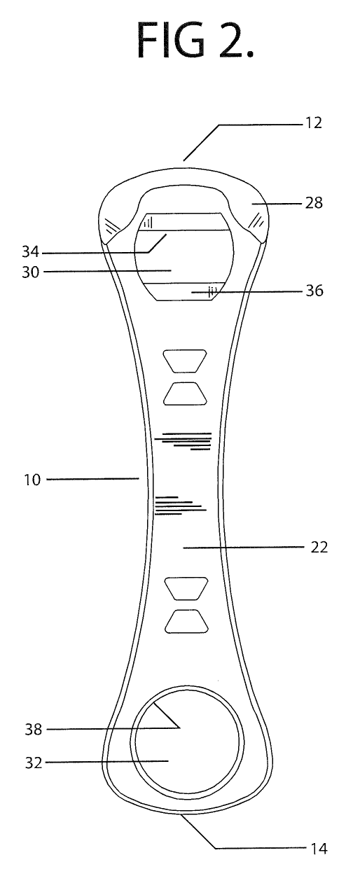

FIG. 3 is a side view of the multi-purpose beverage container opener;

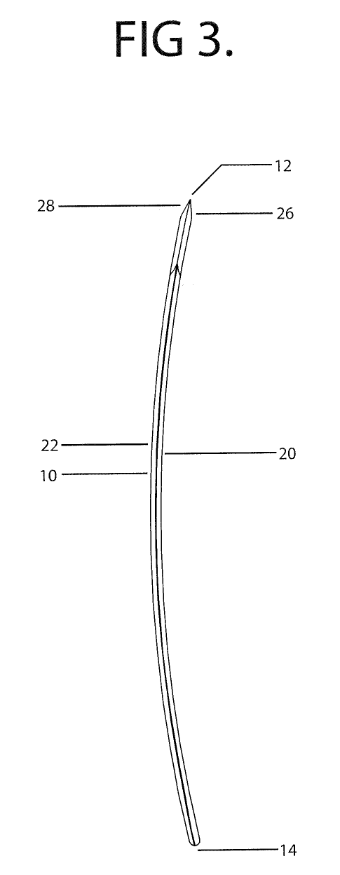

FIG. 4 is an opposite side view of the multi-purpose beverage container opener;

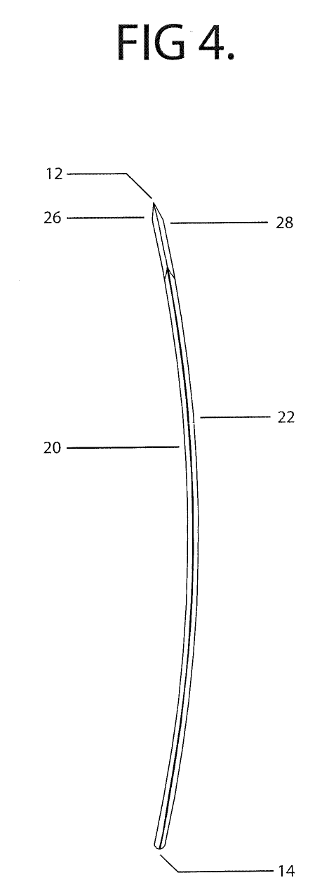

FIG. 5 is an end view of the multi-purpose beverage container opener;

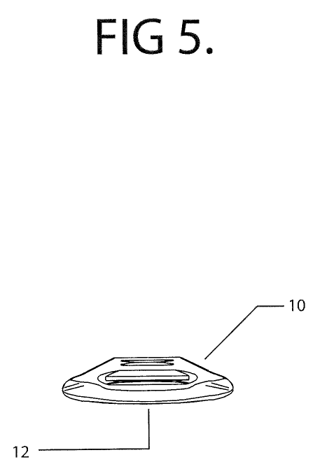

FIG. 6 is an opposite end view of the multi-purpose beverage container opener;

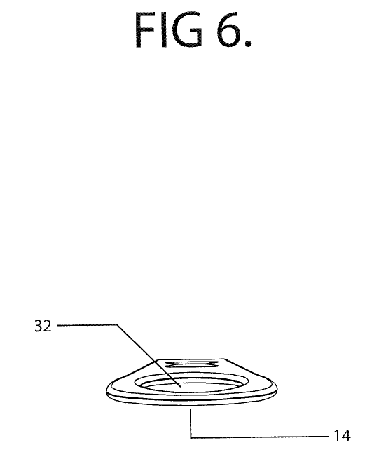

FIG. 7 is a top perspective view of the multi-purpose beverage container opener;

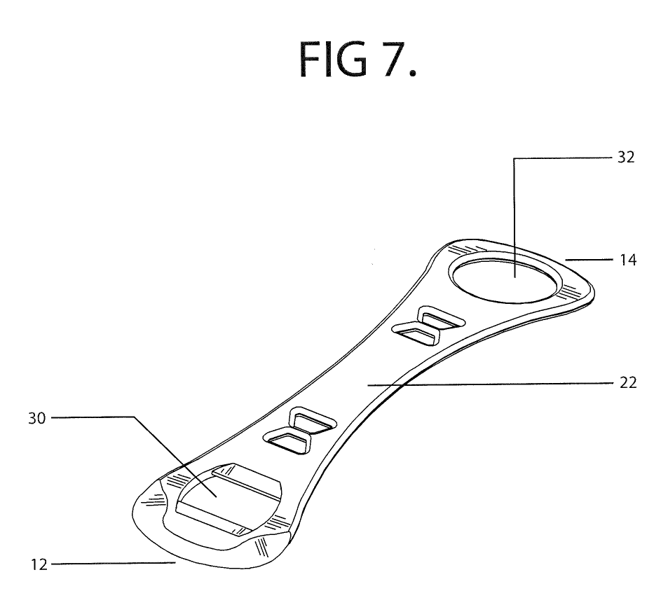

FIG. 8 is a under perspective view of the multi-purpose beverage container opener;

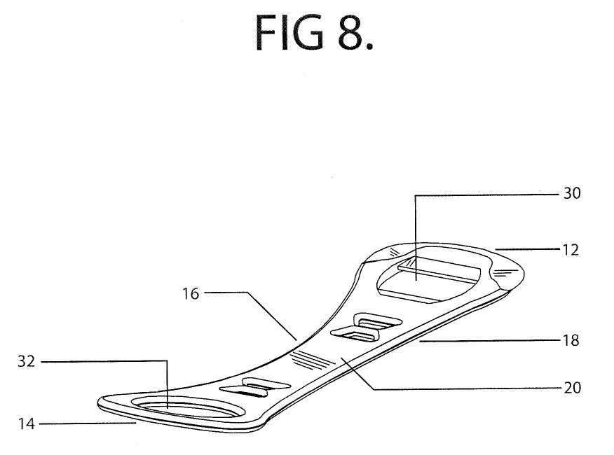

FIG. 9A is a side view of the multi-purpose beverage container opener located in one mode to pry off a cap showing the increased leverage obtained by the bowed structure;

FIG. 9B is a side view of a prior art generic opener located in one mode to pry off a cap showing the limited leverage obtained by the flat structure;

FIG. 10A is a side view of the multi-purpose beverage container opener located in one mode to pry off a cap showing the increased leverage obtained by the bowed structure;

FIG. 10B is a side view of a prior art generic opener located in one mode to pry off a cap showing the limited leverage obtained by the flat structure.

### DESCRIPTION

Similar numerals of reference designate corresponding parts in all view of the drawings.

A multi-purpose beverage container opener for lifting container lid lift tabs and opening bottle caps comprises a thin, relatively elongated and narrow body with two opposite ends.

The body is suitable for holding in a user's thumb and fingers, and the body has a front edge at one end and top and bottom parallel surfaces. The narrow body is arcuate or bowed between its two ends. The front edge includes a beveled surface that extends rearwardly at an acute angle with respect to at least one of the top or the bottom surfaces whereby the opener may be slipped under a container lid tab with the beveled surface.

There is a bottle opener aperture with the surfaces such that a crown cork cap can be pried from the top of a bottle. There is also a ring aperture for engaging a covering of a beverage container neck or top to permit the aperture to cut the covering to facilitate removal of at least part of the covering. The ring aperture may include a beveled edge for facilitating removal of a covering.

The body includes between its two ends a waist, the waist width being of narrower dimension than the width at the ends. The opener includes further apertures spaced in the surface between the ends. The opener also includes a bottle opener located towards one end and the ring aperture is located towards the opposite end.

The opener ends are rounded with respective outwardly directed radii and the interfaces of the ends and the side walls is relatively smooth without sharp corners such that the substantially entire outer periphery is curved.

The beverage container opener for lifting container lid lift tabs and opening bottle caps comprises a thin, relatively elongated and narrow body with two opposite ends, the body having a front edge at one end and top and bottom parallel surfaces, the narrow body being arcuate or bowed between its two ends. The front edge has a beveled surface that extends rearwardly whereby the opener may be slipped under a container lid tab with the beveled surface; and a bottle opener aperture with the surfaces such that a cap can be pried from the top of a bottle. The body includes between its two ends a waist, the waist width being of narrower dimension than the width at the ends. The end surfaces of the body define a periphery, and the corners of the opener at the periphery are rounded with respective outwardly directed radii and the interfaces of the ends and the side walls is relatively smooth without sharp corners such that the substantially entire outer periphery is curved. The cap opener aperture is located towards one end, the cap opener being located adjacent the beveled edge end; and the beveled edge in the front extends to at least one side wall, and preferably both side walls, of the body. The planar material is substantially flat and smooth over its entire surface on both sides and the body is an integrated single piece unitary device. The prying interface edge, the can opener aperture and the ring aperture are the only interruptions in the smooth surfaces.

The multi-purpose beverage container opener comprises a thin, rectangular body 10 having a front edge 12, a rear edge 14, side edges 16 and 18, a top surface 20 and a bottom surface 22. The front edge 12 is provided with a beveled upper surface edge 26, and a lower surface edge 28. The beveled interfaces 26 and 28 provide a container lid tab-contacting surface and the beveled edges that slope at an acute angle with respect to the main area of surfaces 20 and 22. The beveled surface edges 26 and 28 provides a thin lip interface so that the front edge is thinnest at the leading front end 12.

The beveled side edges 28 and 30 are shaped so as to eliminate sharp edges at the edge 12 and 14 respectively. The slope angle of surface 26 is about 30 degrees, with a range of about 25 degrees. to 45 degrees. being suitable. The concavity is sloped rearwardly about 15 degrees with a range of about 10 degrees to 25 degrees being suitable.

The shape of the front edge 12 enables the front edge 12 to be slipped underneath a container lid tab. When the opener is applied to the surface of the can lid, the beveled surface 26 and 28 will be oriented substantially parallel to the lid surface. The opener can be pivoted upward, in a prying manner with the front edge 12 resting on the lid surface underneath the lid tab, resulting in the raising of the tab's outer ring end upward.

The elongated body has a curved shape when considered in plan from the top and the bottom, and is such that the width of the ends adjacent to the edges 12 and 14 are wider than the waist. The waist is located more or less centrally between the edges 12 and 14. The front edge 12 and the rear edge 14, are curved with a radius or parabolic curve or blends smoothly with the side walls 16 and 18 so that the overall shape is curvaceous.

The between the surfaces 20 and 22 the opener includes two apertures 30 and 32 respectively. The aperture 30 is an opener for pry-type bottle crimp-on bottle caps. The aperture 32 is for receiving a cover cap for beverage container, for instance the lead sleeve over wine bottles. Aperture 30 has at least one, and alternatively two edges 34 and 36 which are beveled from the respective surfaces 20 and 22 to a sharpened end to fit under a cap to be pried from the top of a beverage container. The beveling extends around the radius so that it is also partly down the side walls 16 and 18 of the opener. The ring aperture is circular and can have a sharpened beveled edge 38 or this edge or the interface edge can be partly blunted.

The opener is ergonomically-shaped and can be manually grasped by the user. In the operation of the stay-on tab opener, the opener is grasped between the thumb and fingers of the user. The ring aperture 32 is disposed at the end opposite to the end where the pry bottle opener aperture 30 is located. The opener 30 is displaced inwardly from the edges of the body.

The portion 12 of the elongated body of the opener 10 which locates the pry bottle opener aperture 30 and locates the ring aperture 32 in alignment with the major width dimension of the body. The ergonomically-shaped opener handle which extends in a bowed configuration between the edges 12 and 14. The bowing permits for easy lifting from a surface.

The pry-type beverage bottle opener aperture 30 is for removing the crimped-on beverage container cap of a glass beverage container bottle. Such bottle openers comprise an edge 34 or 36 for engaging the beverage container cap and a pry bar for prying up the edge of the cap and removing the same.

The elongated planar body of the multiple-use beverage container opener is easily grasped within the palm and fingers of the user with any stress from the opener evenly distributed over a wide surface area to ensure the safety and comfort of the user.

The opener is formed from sheet steel with stamping and coining steps. The opener may be formed from other materials, such as a polymeric material, with other steps, such as a molding step. An intermediate step in the manufacture of the opener 10 from a malleable metal material such as steel is illustrated. In this case, the malleable metal blank is stamped, cut, or otherwise suitably formed from sheet metal stock with apertures disposed for defining the pry-bar-type opener and the ring aperture respectively.

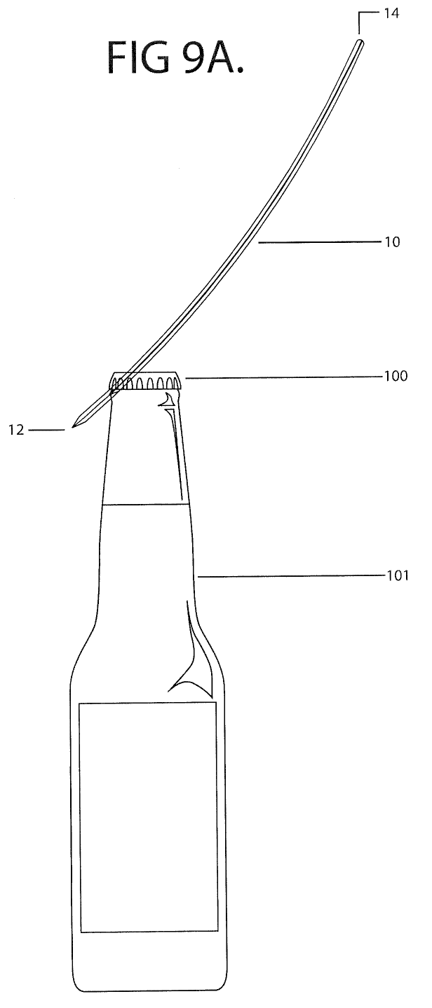

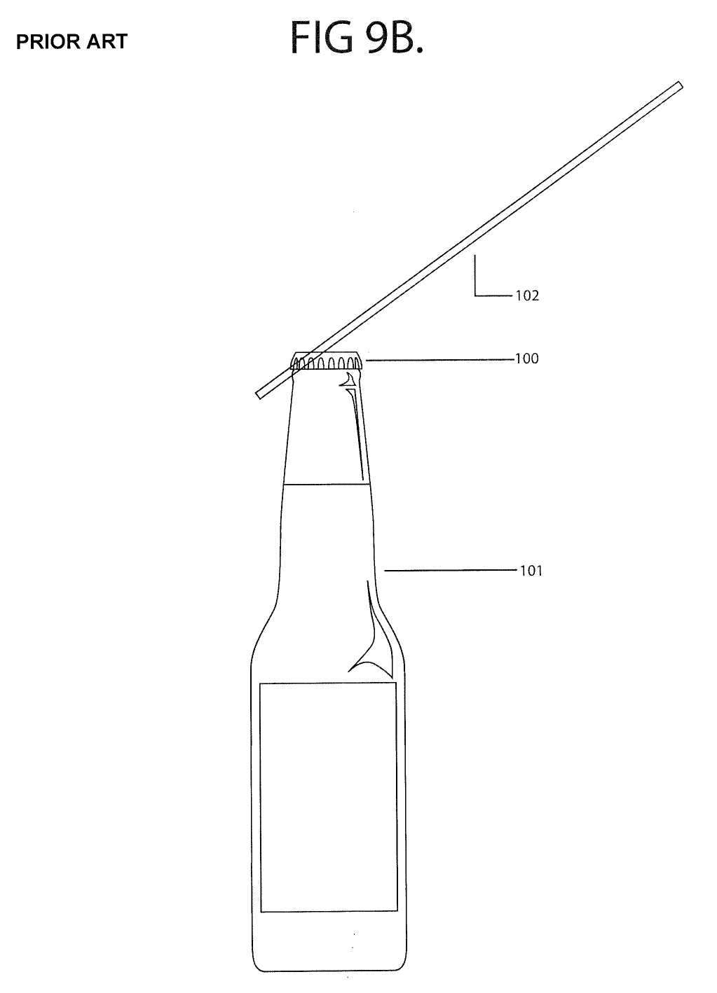

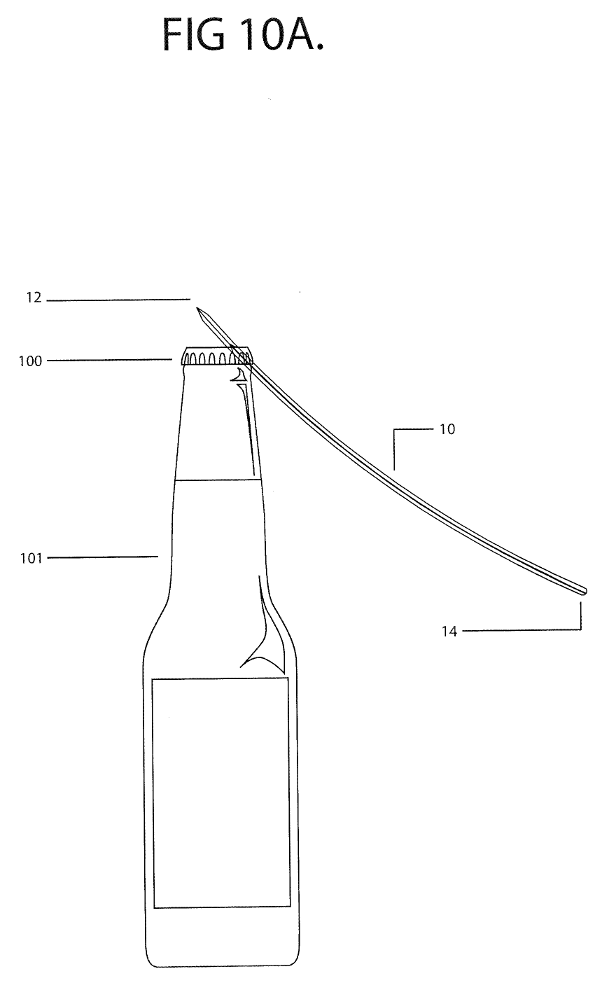

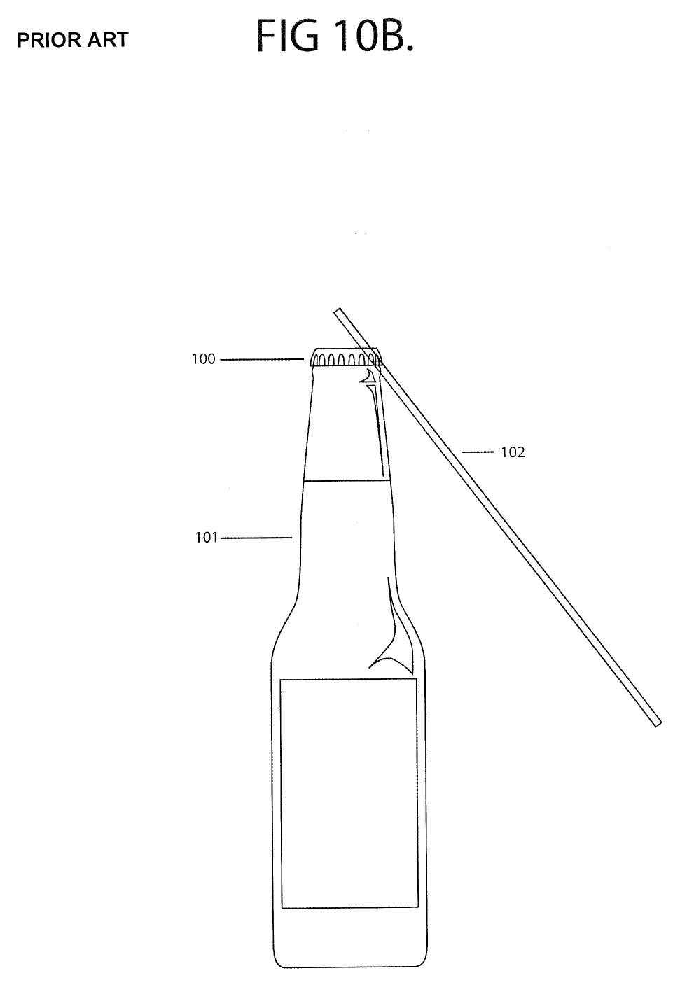

As shown in FIG. 9A the multi-purpose beverage container opener 10 is located in one mode to pry off a cap 100 from a bottle 101. This shows the increased leverage obtained by the bowed structure. Comparatively, in FIG. 9B there is a prior art generic opener 102 located in one mode to pry off a cap 100 showing the limited leverage obtained by the flat structure. FIG. 10A is a different use of the multi-purpose beverage container opener 10 located in another pry off mode on a cap 100 showing the increased leverage obtained by the bowed structure. FIG. 10B is a prior art generic opener 102 located in the pry off a cap 100 showing the limited leverage obtained by the flat structure.

The opener can be fabricated of molded plastic having a suitable formulation that will render the opener sufficiently stiff for the purpose intended. It may also be fabrication from any other suitably stiff material. The opener conveniently has a length of about 2.5 in., a width of about 0.75 in. and a thickness of about ⅛ in. The sloped surface 26 and 28 have a length (front-to-back) of about 3/16 in. and the beveled side edges 28, 30 have a length of about 1/16 in.

While the present disclosure has been disclosed with reference to particular details of construction, these should be understood as having been provided by way of example and not as limitations to the scope or spirit of the disclosure. In particular, the precise cross sectional shape of the elongated member 10 can be varied. The external configuration may be determined by any number of factors both aesthetic and functional. The centrally narrower or thinner art of the body facilitates the operation of the tool. The shape of the apertures may be varied. The ring aperture also permits a user to place finger or thumb in the tool as needed and the shape and outline of the edge can be varied.

It will be understood that the shape of the exterior of the elongated member 10 may be regular, smooth or irregular in cross section, square, or otherwise curved or straight.

The waist between the ends can be of different degrees or shapes of inward pinching, to facilitate different sizes of hands, fingers and anatomical characteristics of a user and the tool itself.

It will also be understood that the size, shape, number and even presence of extending projections on the underside of the head represent design choices over which there is a wide range of latitude. There can be various modifications and similar arrangements included within the spirit and scope of the claims, the scope of which should be accorded the broadest interpretation so as to encompass all such modifications and similar structures. The present disclosure includes any and all embodiments of the following claims.

1. A multi-purpose beverage container opener for lifting container lid lift tabs and opening bottle caps which comprises a thin, relatively elongated and narrow body with two opposite ends, the body being suitable for holding in a user's thumb and fingers; the body having a front edge at one end and top and bottom parallel surfaces, the narrow body being arcuate or bowed between its two ends; the front edge having a beveled surface that extends rearwardly at an acute angle with respect to at least one of the top or the bottom surfaces whereby the opener may be slipped under a container lid tab with the beveled surface; a bottle opener aperture with the surfaces such that a cap can be pried from the top of a bottle; and a ring aperture for engaging a covering of a beverage container neck or top to permit the aperture to cut the covering to facilitate removal of at least part of the covering.

2. The opener of claim 1 wherein the body included between its two ends a waist, the waist width being of narrower dimension than the width at the ends.

3. The opener as claimed in claim 1 wherein the cap opener aperture is located towards one end and the ring aperture is located towards the opposite end of the body, the cap opener preferably being located adjacent the beveled edge end.

4. The opener of claim 1 wherein the beveled edge in the front extends to at least one side wall, and preferably both side walls, of the body

5. The opener of claim 1 including further apertures spaced in the surface between the ends.

6. The opener of claim 1 wherein the bottle opener is located towards one end and the ring aperture is located towards the opposite end.

7. The opener of claim 1 wherein the ring aperture includes a beveled edge for facilitating removal of a covering.

8. The opener of claim 1 wherein the end surfaces of the body define a periphery, and the corners of the opener at the periphery are rounded with respective outwardly directed radii and the interfaces of the ends and the side walls is relatively smooth without sharp corners such that the substantially entire outer periphery is curved.

9. The opener of claim 1 wherein the opener is formed from sheet steel with stamping and coining steps.

10. A beverage container opener for lifting container lid lift tabs and opening bottle caps which comprises a thin, relatively elongated and narrow body with two opposite ends, the body being suitable for holding in a user's thumb and fingers; the body having a front edge at one end and top and bottom parallel surfaces, the narrow body being arcuate or bowed between its two ends; the front edge having a beveled surface that extends rearwardly at an angle with respect to at least one of the top or the bottom surfaces whereby the opener may be slipped under a container lid tab with the beveled surface; a bottle opener aperture with the surfaces such that a cap can be pried from the top of a bottle; and the body included between its two ends a waist, the waist width being of narrower dimension than the width at the ends.

11. The opener as claimed in claim 10 wherein the cap opener aperture is located towards one end, the cap opener preferably being located adjacent the beveled edge end.

12. The opener of claim 10 wherein the beveled edge in the front extends to at least one side wall, and preferably both side walls, of the body.

13. The opener of claim 11 including a ring aperture located towards the opposite end of the body.

14. The opener of claim 11 wherein the bottle opener is located towards one end and the ring aperture is located towards the opposite end.

15. The opener of claim 13 wherein the ring aperture includes a beveled edge for facilitating removal of a covering.

16. The opener of claim 10 wherein the end surfaces of the body define a periphery, and the corners of the opener at the periphery are rounded with respective outwardly directed radii and the interfaces of the ends and the side walls is relatively smooth without sharp corners such that the substantially entire outer periphery is curved.

17. A beverage container opener for lifting container lid lift tabs and opening bottle caps which comprises a thin, relatively elongated and narrow body with two opposite ends, the body being suitable for holding in a user's thumb and fingers; the body having a front edge at one end and top and bottom parallel surfaces, the narrow body being arcuate or bowed between its two ends; the front edge having a beveled surface that extends rearwardly at an angle with respect to at least one of the top or the bottom surfaces whereby the opener may be slipped under a container lid tab with the beveled surface; a bottle opener aperture with the surfaces such that a cap can be pried from the top of a bottle; and the body included between its two ends a waist, the waist width being of narrower dimension than the width at the ends, wherein the end surfaces of the body define a periphery, and the corners of the opener at the periphery are rounded with respective outwardly directed radii and the interfaces of the ends and the side walls is relatively smooth without sharp corners such that the substantially entire outer periphery is curved; and wherein the cap opener aperture is located towards one end, the cap opener being located adjacent the beveled edge end; and wherein the beveled edge in the front extends to at least one side wall, and preferably both side walls, of the body.

18. The opener of claim 17 including a ring aperture located towards the opposite end of the body.

19. The opener of claim 17 wherein the planar material is substantially flat and smooth over its entire surface on both sides and the body is an integrated single piece unitary device.
